(19) United States
(12) Patent Application Publication
(10) Pub. No.: US 2006/0023063 A1
(43) Pub. Date: Feb. 2, 2006

(54) Image sharing display system, terminal with image sharing function, and computer program product

(75) Inventor: Tomoki Okawa, Tokyo (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 11/188,786

(22) Filed: Jul. 26, 2005

(30) Foreign Application Priority Data
Jul. 27, 2004 (JP) 2004-218538

(51) Int. Cl. H04N 7/14

(52) U.S. Cl. 348/14.09

(57) ABSTRACT

A first terminal constituting an image sharing display system shares an image with a second terminal constituting the system. Display area information is transmitted from the second terminal. In the first terminal, which portion of the shared image is currently displayed on the second display screen of the second terminal is displayed on a first screen, as a frame-like pointer, on the basis of the display area information.

### BACKGROUND OF THE INVENTION

1. Field of the Invention

The present invention relates to an image sharing display system, a terminal with an image sharing function, and a computer program product.

2. Description of the Related Art

A terminal apparatus for sharing a screen, for example, between or among a plurality of apparatuses has been suggested (e.g. refer to Japanese Patent Application Laid Open NO. 2001-157184).

According to a screen sharing terminal apparatus disclosed in Japanese Patent Application Laid Open NO. 2001-157184 (hereinafter referred to as a “related art”), the same screen is displayed on one terminal apparatus and on the other terminal apparatus. If the one terminal apparatus points out predetermined point on this screen, an arm-like pointer extends on the screen of each terminal apparatus, to thereby indicate the pointed point. The start point of this arm-like pointer varies in each terminal apparatus. Thus, it is said that each terminal apparatus can be identified or distinguished on the same screen.

However, the related art has the following problem.

For example, in the case of a meeting held by using the plurality of terminal apparatuses, the mutually different screen sizes of the plurality of terminal apparatuses may cause the point indicated by the one terminal to be out of the display range of the other terminal in some cases. In such a case, since the indicated point is originally out of the screen, an identifiably constructed pointer has little meaning. Moreover, in the one terminal, it is not recognized that the point indicated by the one terminal is not displayed in the other terminal, so that the progress of the meeting or the like easily tends to be one-sided. Namely, in the related art, there is a technical problem that smooth communication cannot be made, in sharing the screen between or among the plurality of apparatuses.

### SUMMARY OF THE INVENTION

It is therefore an object of the present invention to provide: an image sharing display system, a terminal with an image sharing function, and a computer program product, which can realize smooth communication.

The above object of the present invention can be achieved by an image sharing display system, provided with: at least one first terminal and at least one second terminal which are accommodated in a network and which can mutually share an image, the first terminal provided with: a first screen device for displaying the image; a first display controlling device for controlling the first screen device to display at least one portion of the image; a first display area information generating device for generating first display area information which indicates a first area occupied by the at least one portion displayed on the first screen device with respect to a whole area of the image; and a first communicating device for transmitting the generated first display area information to the second terminal through the network, the second terminal provided with: a second screen device for displaying the image; and a second display controlling device for controlling the second screen device to display at least one portion of the image.

The “network” of the present invention is defined, including all or part of a wired communication network, represented by the Internet and a Local Area Network (LAN) or the like, and a wireless communication network used for a mobile phone, a Personal Digital Assistance (PDA), a car navigation apparatus or the like.

According to the image sharing display system of the present invention, in operation thereof, at least one portion of the image is displayed on the first screen device by virtue of the first display controlling device in the first terminal and on the second screen device by virtue of the second display controlling device in the second terminal.

The “image” of the present invention includes images for information materials used in various meetings, such as a project meeting and a sales meeting or various types of similar meetings, images presented in various services, such as a searching service and a map information service, motion pictures, such as a movie and a drama, various text images, and the like. The “image” indicates some visual information which can be shared between or among the plurality of terminals through the above-mentioned network.

The “screen device” of the present invention indicates a display screen for displaying the image, and various display apparatuses having the display screen, such as a plasma display, a liquid crystal display (LCD), a Cathode Ray Tube (CRT) display, an organic electroluminescence (EL) display and the like.

On each screen device, at least one portion of the image to be shared is displayed, depending on the type, aspect, performance, setting or specifications of each of the first terminal and the second terminal. For example, a wider range of image can be displayed on a screen device with a relatively large display area than that of a screen device with a relatively small display area. In such a condition that at least one portion is displayed, as described above, each terminal can display the whole image by scrolling, scaling or changing over the screen. Namely, in the image sharing display system of the present invention, each terminal can control or allow its own screen device to display the mutually equal image.

The “display controlling device” of the present invention indicates various computer apparatuses and systems, such as a microcomputer, a personal computer, a work station, and a server. The display controlling device may be unified with the screen device, partially or as a whole. Therefore, the “terminal” of the present invention can adopt various aspects, such as various computer systems provided with a microcomputer, a personal computer, a work station, a server, and the like, a mobile phone, a PDA, and a car navigation apparatus.

In particular, even if the screen can be mutually shared, the communication becomes one-sided in some cases, as already described above. More specifically, for example, if the screen of one terminal is larger than that of the other terminal, the point indicated in the one terminal may not be displayed in the other terminal.

However, according to the image sharing display system of the present invention, the problem can be solved by providing the first terminal with the first display area information generating device.

Namely, in the image sharing display system of the present invention, if the image is shared, the first display area information generating device generates the first display area information which indicates the first area occupied by the at least one portion displayed on the first screen device with respect to the whole area of the image. The generated first display area information is transmitted to the second terminal through the network by the first communicating device.

In the second terminal, it is possible to recognize which portion of the shared image is currently displayed on the first screen device of the first terminal, by the transmitted first display area information. Namely, on the second terminal side, it is possible to recognize the display state of the first terminal side, so that it is possible to realize smooth communication and extremely effective and efficient image sharing. As a method of the second terminal notifying or informing, to the user, the portion displayed on the first screen device of the first terminal, which is recognized in the second terminal as described above, various output methods can be considered, such as display output or audio output, which excite the five senses of the user, such as eyesight, hearing, and touch.

Incidentally, the “first display area information generating device” as described above may be mounted in the same hardware as that of the above-mentioned first display controlling device or in the same hardware as that of the first screen device.

With respect to the size of the display areas of the first screen device and the second screen device in the first terminal and the second terminal in the present invention, either of the display areas may be relatively large, or the both may be equal. Regardless of the aspect of each screen device, it is possible to receive the effect of the image sharing display system of the present invention. Moreover, the “size of the display area” is not simply limited to the physical size of the display area, such as the screen size, but includes the number of pixels displayable on one screen, which is referred to as “resolution”. Therefore, it is obvious that there are the case where the number of pixels displayable on one screen is different but the screen size is the same and the case where the screen size is different but the number of pixels displayable on one screen is the same.

In one aspect of the image sharing display system of the present invention, the second terminal is further provided with: a second display area information generating device for generating second display area information which indicates a second area occupied by the at least one portion displayed on the second screen device with respect to the whole area of the image; and a second communicating device for transmitting the generated second display area information to the first terminal through the network.

According to this aspect, the second display area information which indicates the second area occupied by the at least one portion displayed on the second screen device with respect to the whole area of the image is generated by the second display area information generating device provided in the second terminal. The second display area information is transmitted to the first terminal through the network by the second communicating device.

Namely, according to this aspect, the portion of the shared image displayed on the first screen device of the first terminal can be recognized in the second terminal, and the portion of the shared image displayed on the second screen device of the second terminal can be recognized in the first terminal. Therefore, it is possible to make communication, more smoothly.

In this aspect, the second terminal is provided with the second display area information generating device and the second communicating device, so that the structure of the second terminal can be the same as that of the first terminal. Namely, in the present invention, the first terminal and the second terminal may be mutually equal or different in the structure, as long as capable of mutually sharing the image.

In one aspect of the image sharing display system provided with the second display area information generating device, the second display controlling device controls the second screen device to display information corresponding to the first area, on the basis of the transmitted first display area information.

According to this aspect, the information corresponding to the above-mentioned first area is displayed on the second screen device. The “information corresponding” indicates a frame or similar things which are displayed on the second screen device in order to represent the first area. Alternatively, it indicates visual information, such as hatching, which is provided for the area. Alternatively, it indicates an indication image, such as a pointer, for indicating the position of the first area. Moreover, it indicates position information, such as coordinate information, corresponding to the first area. Alternatively, the “information corresponding” may be displayed by changing a display color only in the portion corresponding to the first area, on the second screen device. Namely, as long as the first area can be visually recognized on the second screen device, the aspect of the “information corresponding” may be arbitrarily determined.

According to this aspect, on the second terminal side, it is possible to recognize which portion of the shared image is currently displayed in the first terminal. Thus, it is possible to realize extremely smooth communication.

In such an image sharing display system, the second screen device may have a larger display area than that of the first screen device. In this case, it is effective since the display state of the first terminal can be recognized, more easily, on the second terminal side.

The “larger display area” herein is not simply limited to the physical size of the display area, such as the screen size, but includes the number of pixels which can be displayed on one screen, which is referred to as “resolution”. Therefore, it also includes the case where the number of pixels displayable on one screen is different but the screen size is the same, or on the contrary, the case where the screen size is different but the number of pixels displayable on one screen is the same. Even if it is said that the display area is large, the display area does not have to be large both vertically and horizontally. It may be large only vertically, or only horizontally.

In another aspect of the image sharing display system of the present invention, the first display controlling device controls the first screen device to display information corresponding to the second area, on the basis of the transmitted second display area information.

According to this aspect, the information corresponding to the second area is displayed on the first screen device, in the same various forms as previously displayed on the second screen device. Therefore, it is possible to realize which portion of the shared image is displayed on the first or second screen device in a two-way manner between the first and second terminals. Thus, it is possible to make communication, more smoothly.

In another aspect of the image sharing display system of the present invention, the second terminal is further provided with an area designation information generating device for generating area designation information which designates an area of the image to be displayed on the first screen device, the second communicating device transmits the generated area designation information to the first terminal, and the first display controlling device controls the first screen device to display the designated area, on the basis of the transmitted area designation information.

According to this aspect, the area designation information generated in the second terminal is transmitted by the second communicating device. The portion of the shared image corresponding to the designated area is displayed on the first screen device of the first terminal, on the basis of the transmitted area designation information.

The term “designates the area” can adopt various aspects. For example, the area may be designated by operating the “information corresponding to the first area” displayed on the second screen. In this case, if the corresponding information is displayed in a frame form on the second screen device, this frame may be forcibly displaced to a predetermined position on the second screen device, to thereby designate the area. The forcible displacement of the frame may be performed through an inputting device, such as a keyboard, a mouse, a touch pad, and a scroll button, for example. Alternatively, the area may be designated by merely inputting the position information, such as coordinate information, about the area an operator desires to display on the first screen device.

Namely, according to this aspect, the second terminal can give superior control to the first terminal through the network, by generating and transmitting the area designation information, as occasion demands. Therefore, for example, if there is a terminal corresponding to a host in a meeting or the like and there is rank order in at least one portion of terminals, a higher-order terminal can easily control a lower-order terminal. Thus, it is possible to make communication, more smoothly.

In one aspect of the image sharing display system provided with the second communicating device, the second terminal is further provided with an indicated point information generating device for generating indicated point information which represents a point indicated in the second area, the second communicating device transmits the generated indicated point information to the first terminal, and the first display controlling device controls the first screen device to display information corresponding to the indicated point, on the basis of the transmitted indicated point information.

According to this aspect, the indicated point information which represents the point indicated in the second area is generated on the second terminal side, and the generated indicated point information is transmitted to the first terminal.

The “point indicated in the second area” herein indicates a point on the image displayed on the second screen device, which is indicated by the operator of the second terminal, through various inputting device, such as a mouse, a keyboard, a touch pad, a scroll button, or audio recognizing apparatus. Incidentally, the “point” herein may be what indicates one point on the shared image, or what indicates a certain amount of range.

On the first terminal side, the information corresponding to the indicated point is displayed on the first screen device, on the basis of the indicated point information. The “information corresponding to the indicated point” indicates a pointer having various shapes, such as an arrow shape or a hand shape, or an indication frame, or the like. Moreover, the indicated point may be displayed by hatching or the like. Furthermore, the indicated point may be displayed by changing the display color of the indicated point. Alternatively, the indicated point may be recognizably displayed by textual information or the like. Namely, as long as it is visual information which can recognize, on the first screen device, the point indicated in the second area, the aspect of the information corresponding to the indicated point may be arbitrary.

According to this aspect, on the first terminal side, it is possible to recognize the point which is a current issue on the second terminal side. Thus, it is possible to make communication, more smoothly.

In one aspect of the image sharing display system provided with the indicated point information generating device, the first display controlling device controls the first screen device to display at least one portion of the image so as to include the indicated point in a first range set in advance on the first screen device, on the basis of the transmitted indicated point information.

According to this aspect, at least one portion of the image is displayed on the first screen device so as to include the point indicated in the second area in the first range set in advance on the first screen device. The “first range” herein is, for example, a range arbitrarily set on the first screen device, and may be the whole first screen device. In this case, it is enough only if the indicated point is displayed on the first screen device. Moreover, the image may be also displayed so as to display the indicated point related to the center of the first range. Incidentally, as long as the image is displayed so as to include the indicated point in the first range, the aspect of displaying the image on the first screen device may be arbitrary.

According to this aspect, it is possible to maintain the display content of the first screen device in a proper condition. Thus, this is extremely useful when the operator of the first terminal is busy with some operations, for example.

Moreover, in this aspect, the first terminal may be further provided with a judging device for judging whether or not the indicated point is out of a second range set in advance on the first screen device, and the first display controlling device may control the first screen device to display at least one portion of the image so as to include the indicated point in the first range, if it is judged by the judging device that the indicated point is our of the second range.

According to this aspect, if the point indicated in the second area is out of the second range set in advance on the first screen device, the image is displayed so as to include the indicated point in the above-mentioned first range. The “second range” herein may be designated to be the same range as or a larger range than the first range.

According to this aspect, if the point indicated in the second area is displayed in the second range set in advance in the first terminal, the display of the first screen device is not changed over. Therefore, whether or not the indicated point is fully recognizably displayed on the first screen device, the comfort of the first terminal side is improved without frequently scrolling and changing over the image with little meaning in practice.

In another aspect of the image sharing display system of the present invention, the image is supplied in advance from the first or second terminal through the first or second communicating device.

According to this aspect, the shared image is supplied from either of the first and second terminals. At this time, the image is supplied through the network by using the first or second communicating device, for example. Therefore, it is possible to smoothly share the image between the terminals, and improve the comfort.

When the image to be shared is distributed to each terminal, the display area information of the screen device which is suitable for the display of the image may be designated in advance as a value, such as the number of pixels (e.g. XGA (Extended Graphics Array), VGA (Video Graphics Array), etc.), for example. In this case, the size of the image and text displayed on the display screen is integrated between the terminals, so that it is desirable.

### Terminal with Image Sharing Function

The above object of the present invention can be also achieved by a terminal with an image sharing function which is accommodated in a network and which can mutually share an image through the network with another terminal having a first screen device for displaying at least one portion of the image, the terminal with the image sharing function comprising: a second screen device for displaying the image; and a display controlling device for controlling the second screen device to display at least one portion of the image, the display controlling device controlling the second screen device to display information corresponding to a first area, on the basis of first display area information which is transmitted from the another terminal and which indicates a first area occupied by the at least one portion displayed on the first screen device with respect to a whole area of the image.

According to the terminal with the image sharing function of the present invention, the information corresponding to the first area is displayed on the second screen device by virtue of the display controlling device, wherein the first area is an area occupied by the at least one portion of the shared image displayed on the first screen device, which is provided for the another terminal accommodated in the network, with respect to the whole area of the image. Thus, it is always possible to recognize or understand which portion of the image shared in the another terminal is displayed, and thus realize smooth communication.

In one aspect of the terminal with the image sharing function of the present invention, it is further provided with: an indicated point information generating device for generating indicated point information which represents a point indicated on the second screen device; and a communicating device for transmitting the generated indicated point information through the network, the terminal with the image sharing function allowing the first screen device to display at least one portion of the image so as to include the indicated point, on the basis of the transmitted indicated point information.

According to this aspect, by virtue of the indicated point information, the point indicated on the second screen device can be displayed on the first screen device of the another terminal. Thus, it is possible to realize communication, more smoothly.

### First Computer Program Product

The above object of the present invention can be also achieved by a first computer program product in a computer-readable medium for tangibly embodying a program of instructions executable by a computer system to make the computer system function as the above-mentioned first terminal (including its various aspects).

According to the first computer program product of the present invention, the first terminal in the image sharing display system of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device. More specifically, the computer program product may include computer readable codes to cause the computer (or may comprise computer readable instructions for causing the computer) to function as the first terminal in the image sharing display system of the present invention described above.

Incidentally, in response to various aspects of the first terminal in the image sharing display system of the present invention described above, the first computer program product of the present invention can also adopt various aspects.

### Second Computer Program Product

The above object of the present invention can be also achieved by a second computer program product in a computer-readable medium for tangibly embodying a program of instructions executable by a computer system to make the computer system function as the above-mentioned second terminal (including its various aspects).

According to the second computer program product of the present invention, the second terminal in the image sharing display system of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer system, or by downloading the computer program product, which may be a carrier wave, into the computer system via a communication device. More specifically, the computer program product may include computer readable codes to cause the computer (or may comprise computer readable instructions for causing the computer) to function as the second terminal in the image sharing display system of the present invention described above.

Incidentally, in response to various aspects of the second terminal in the image sharing display system of the present invention described above, the second computer program product of the present invention can also adopt various aspects.

As explained above, the image sharing display system is provided with the first terminal and the second terminal, so that it is possible to realize smooth communication between or among the plurality of terminals which can share the image. The terminal with the image sharing function is provided with the second screen device and the display controlling device, so that it is possible to realize smooth communication between or among the plurality of terminals which can share the image. The first computer program product makes the computer system function as the above-mentioned first terminal, so that it is possible to realize the first terminal in the image sharing display system, relatively easily. The second computer program product makes the computer system function as the above-mentioned second terminal, so that it is possible to realize the second terminal in the image sharing display system, relatively easily.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a conceptual diagram showing an image sharing display system according to an embodiment of the present invention;

FIG. 2 is a block diagram showing one terminal system in the image sharing display system of FIG. 1;

FIG. 3 is a block diagram showing another terminal system in the image sharing display system of FIG. 1;

FIG. 4 is a flowchart showing an image sharing process related to the operation example of the image sharing display system of FIG. 1;

FIG. 5 is a schematic diagram showing a shared image related to the image sharing process of FIG. 4;

FIG. 6 is another schematic diagram showing a shared image related to the image sharing process of FIG. 4;

FIG. 7 is a flowchart showing a display area displaying process related to the operation example of the image sharing display system of FIG. 1;

FIG. 8 is a schematic diagram showing a display screen related to the display area displaying process of FIG. 7;

FIG. 9 is a flowchart showing an indicated point displaying process related to the operation example of the image sharing display system of FIG. 1;

FIG. 10A to FIG. 10C are schematic diagrams showing display screens related to the indicated point displaying process of FIG. 9; and

FIG. 11A and FIG. 11B are schematic diagrams showing a display device according to a modified example of the present invention.

### DETAILED DESCRIPTION OF THE PREFERRED EMBODIMENT

The embodiment of the present invention will be explained with reference to the drawings hereinafter.

### Structure of Embodiment

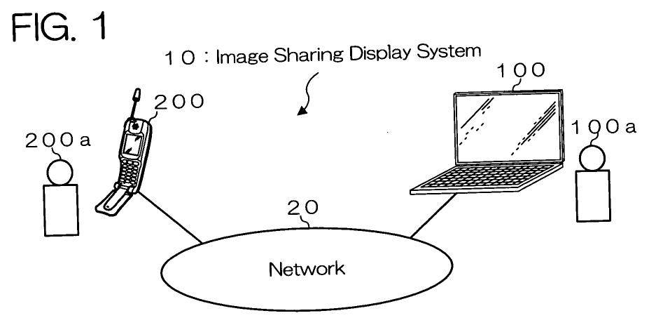

At first, with reference to FIG. 1, the structure of an image sharing display system according to the embodiment of the present invention will be explained. FIG. 1 is a conceptual diagram showing an image sharing display system 10.

In FIG. 1, the image sharing display system 10 is a system in which a terminal system 100 and a terminal system 200 are accommodated in a network 20.

The terminal system 100 is a computer system, such as a personal computer, for example, and is used by a user 100a in a facility, such as a company. The terminal system 100 functions as one example of the “second terminal” or the “terminal with the image sharing function” of the present invention. The terminal system 200 is a mobile communication system, such as a mobile phone, for example, and is used by a user 200a who is in a different place from the terminal 100. The terminal system 200 is one example of the “first terminal” of the present invention.

The network 20 includes a wired LAN network set in the facility or the like where the user 100a is located, the Internet connected through the wired LAN network, a wireless communication network which can connect to the Internet, and the like. The network 20 is one example of the “network” of the present invention.

In the image sharing display system 10, the users 100a and 200a can access the network 20 by using the respective terminal systems 100 and 200 and can have a meeting by mutually sharing an image in the terminal systems 100 and 200.

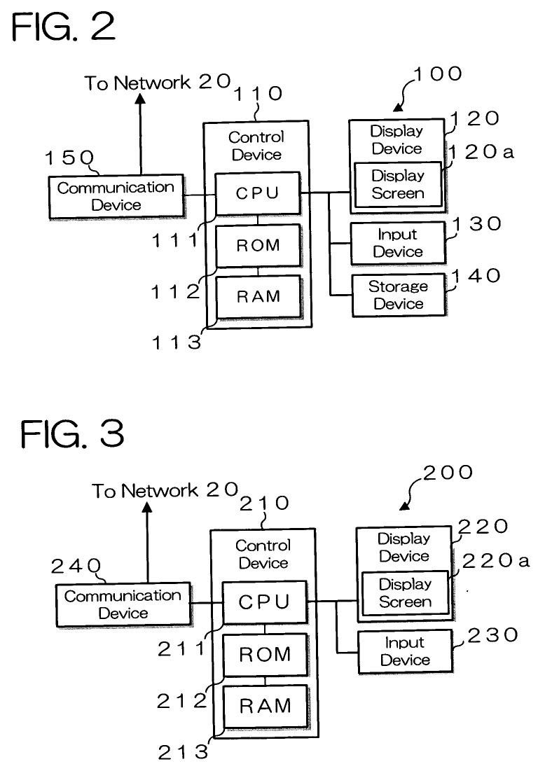

Next, with reference to FIG. 2, the structure of the terminal system 100 will be explained. FIG. 2 is a block diagram showing the terminal system 100.

In FIG. 2, the terminal system 100 is provided with: a control device 110; a display device 120; an input device 130; a storage device 140; and a communication device 150.

The control device 110 is provided with: a Central Processing Unit (CPU) 111; a Read Only Memory (ROM) 112; and a Random Access Memory (RAM) 113.

The CPU 111 is a unit for controlling the operation of the terminal system 100. The ROM 112 is a memory exclusive for reading. The ROM 112 stores therein an image sharing display program which can be executed by the CPU 111 and which is one example of the “computer program product” of the present invention. The RAM 113 is a rewritable memory. The RAM 113 can temporarily store therein data generated in a procedure in which the CPU 111 executes the image sharing display program. Incidentally, the CPU 111 can function as one example of each of the “second display controlling device”, the “second display area information generating device”, and the “indicated point information generating device” of the present invention, by executing the image sharing display program stored in the ROM 112.

The display device 120 is a display apparatus, such as a liquid crystal display apparatus, having a display screen 120a. The display device 120 can display the image shared by the terminal system 100 and the terminal system 200. The display device 120 is one example of the “second screen device” of the present invention. Incidentally, the display device 120 can adopt various aspects, for example, such as a plasma display apparatus, a CRT display apparatus, and an organic EL display apparatus, depending on the aspect of the terminal system 100. Moreover, the display device 120 may be unified with the control device 110, such as a laptop computer. The display device 120 may be constructed individually, aside from the control device 110, such as a desktop computer.

The input device 130 is various types of inputting devices, such as a keyboard, a mouse, a touch pad, and a scroll button, for example. The input device 130 can give various instructions to the control device 110, by the operation of the user 100a.

The storage device 140 is provided with, for example, a magnetic recording medium, such as a HD, or an optical information recording medium, such as a DVD-RAM and a CD-RW, and various drive units corresponding to those recording media. The storage device 140 stores therein image data related to the image shared with the terminal system 200, or the like.

The communication device 150 can access the network 20, and is one example of the “second communicating device” of the present invention.

Next, with reference to FIG. 3, the structure of the terminal system 200 will be explained. FIG. 3 is a block diagram showing the terminal system 200.

In FIG. 3, the terminal system 200 is provided with: a control device 210; a display device 220; an input device 230; and a communication device 240.

The control device 210 is provided with: a CPU 211; a ROM 212; and a RAM 213.

The CPU 211 is a unit for controlling the operation of the terminal system 200. The ROM 212 is a memory exclusive for reading. The ROM 212 stores therein an image sharing display program which can be executed by the CPU 211 and which is another example of the “computer program product” of the present invention. The RAM 213 is a rewritable memory. The RAM 213 can temporarily store therein data caused in a procedure in which the CPU 211 executes the image sharing display program. Incidentally, the CPU 211 can function as one example of each of the “first display controlling device”, the “first display area information generating device”, and the “judging device” of the present invention, by executing the image sharing display program stored in the ROM 212.

The display device 220 is a display apparatus, such as a liquid crystal display apparatus, having a display screen 220a with a smaller display area than that of the display screen 120a. The display device 220 can display the image shared by the terminal system 100 and the terminal system 200. The display device 220 is one example of the “first screen device” of the present invention. Incidentally, the display device 220 can adopt various types of aspects, depending on the aspect of the terminal system 200, as in the display device 120.

The input device 230 is various types of inputting devices, such as a keyboard and a scroll button, for example. The input device 230 can give various instructions to the control device 210, by the operation of the user 200a.

The communication device 240 can access the network 20, and is one example of the “first communicating device” of the present invention.

Incidentally, the terminal system 200 may be provided with a storage device, as in the terminal system 100. If the storage device is provided, image data related to the image shared with the terminal system 100 may be stored therein.

### Operation of Embodiment

Next, the operation of the image sharing display system having the above-mentioned structure will be explained for each of the various processes performed by each control device of both the terminal system 100 and the terminal system 200. Incidentally, the process is realized by that the CPUs 111 and 211 of the control devices 110 and 210 execute the respective image sharing display programs stored in the ROMs 112 and 212, respectively.

### 1. Image Sharing Process

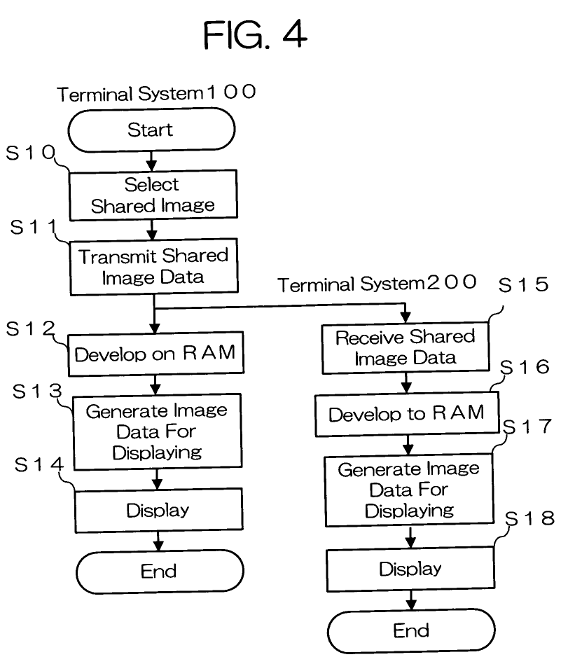

At first, with reference to FIG. 4, a process for mutually sharing an image between the terminal systems will be explained. FIG. 4 is a flowchart showing the image sharing process.

In FIG. 4, in the terminal system 100, an image to be shared (hereinafter referred to as a shared image, as occasion demands) is selected (step S10). The shared image herein is an image of information materials for a meeting held by the user 100a and the user 200a, for example. The CPU 111 selects image data related to the shared image from the storage device 140 (hereinafter referred to as “shared image data”, as occasion demands) and temporarily stores it in the RAM 113.

Then, the CPU 111 transmits the shared image data stored in the RAM 113 to the terminal system 200 through the communication device 150 (step S11). Incidentally, the process of the terminal system 200 as being the destination will be explained later.

After transmitting the shared image data to the terminal system 200, the CPU 111 develops the shared image on the RAM 113, on the basis of the shared image data (step S12). The CPU 111 further selects a portion which is displayed on the display screen 120a, out of the shared image developed on the RAM 113, to thereby generate image data for displaying of the selected portion (step S13). The CPU 111 allows or controls the display screen 120a to display one portion of the shared image, on the basis of the image data for displaying (step S14). Then, the process on the terminal system 100 side ends.

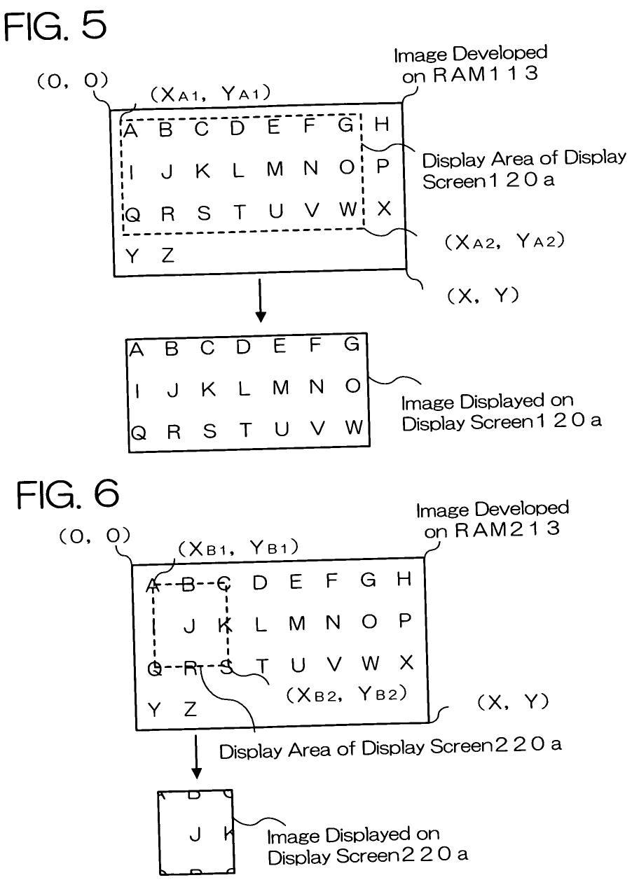

Now, with reference to FIG. 5, the display form of the shared image in the terminal system 100 will be explained. FIG. 5 is a schematic diagram showing the shared image.

In FIG. 5, it is assumed that the image developed on the RAM 113 has a size defined as coordinates (0, 0) to coordinates (X, Y) on a plane of coordinates, for convenience. The display area of the display screen 120a has a size corresponding to coordinates (X_{A1}, Y_{A1}) to coordinates (X_{A2}, Y_{A2}) (wherein X_{A2}<X, and Y_{A2}<Y) on this plane of coordinates. The CPU 111 operates and generates the image data for displaying, for a portion surrounded by a dashed line in FIG. 5. As a result, as shown in the lower part of FIG. 5, an image including “A” to “W” is displayed on the display screen 120a. Incidentally, in the terminal system 100, the user 100a can use the input device 130 to arbitrarily change the portion of the shared image displayed on the display screen 120a. For example, such a change can be easily made by scrolling this area with an inputting device, such as a mouse, or by similar actions.

Back in FIG. 4, the process on the terminal system 200 side will be explained.

In the terminal system 200, which is the destination of the shared image data, the shared image data is received by the communication device 240 (step S15). The CPU 211 develops this shared image data received, on the RAM 213 (step S16). The CPU 211 further selects a portion which is displayed on the display screen 220a, out of the shared image developed on the RAM 213, to thereby generate image data for displaying of the selected portion (step S17). The CPU 211 allows or controls the display screen 220a to display one portion of the shared image, on the basis of the image data for displaying (step S18). Then, the process on the terminal system 200 side ends.

Now, with reference to FIG. 6, the display form of the shared image in the terminal system 200 will be explained. FIG. 6 is a schematic diagram showing the shared image.

In FIG. 6, it is assumed that the image developed on the RAM 213 has a size defined as coordinates (0, 0) to coordinates (X, Y) on a plane of coordinates, for convenience. The display area of the display screen 220a has a size corresponding to coordinates (X_{B1}, Y_{B1}) to coordinates (X_{B2}, Y_{B2}) (wherein X_{B2}<X, and Y_{B2}<Y) on this plane of coordinates. The CPU 211 operates and generates the image data for displaying, for a portion surrounded by a dashed line in FIG. 6. As a result, as shown in the lower part of FIG. 6, an image centering on “J” is displayed on the display screen 220a. Incidentally, in the terminal system 200, it is possible to use the input device 230 to change the portion of the shared image displayed on the display screen 220a. For example, such a change can be easily made by scrolling this area with an inputting device, such as a scroll button, or by similar actions.

In the image sharing display system 10, at first, the image is shared between the terminal system 100 and the terminal system 200, by the image sharing process, as described above. Incidentally, the shared image data may be transmitted from the terminal system 200 to the terminal system 100.

For example, in the case where the shared image data is transmitted from the terminal system 200 to the terminal system 100, if the terminal system 200 is provided with a storage device, the shared image data read out from the storage device may be transmitted to the terminal system 100. Moreover, the image shared by the terminal system 100 and the terminal system 200 is not necessarily the one based on the image data stored in the storage device 140 (including a storage device provided for the terminal system 200 if there is the one). For example, the image may be shared on the basis of the image data downloaded to the RAM from the exterior. Alternatively, the shared image data may be stored in the ROM in advance. For example, if the terminal system 200 is a camera-equipped mobile phone, the image may be shared on the basis of the image data stored into the RAM from the camera.

### Display Area Displaying Process

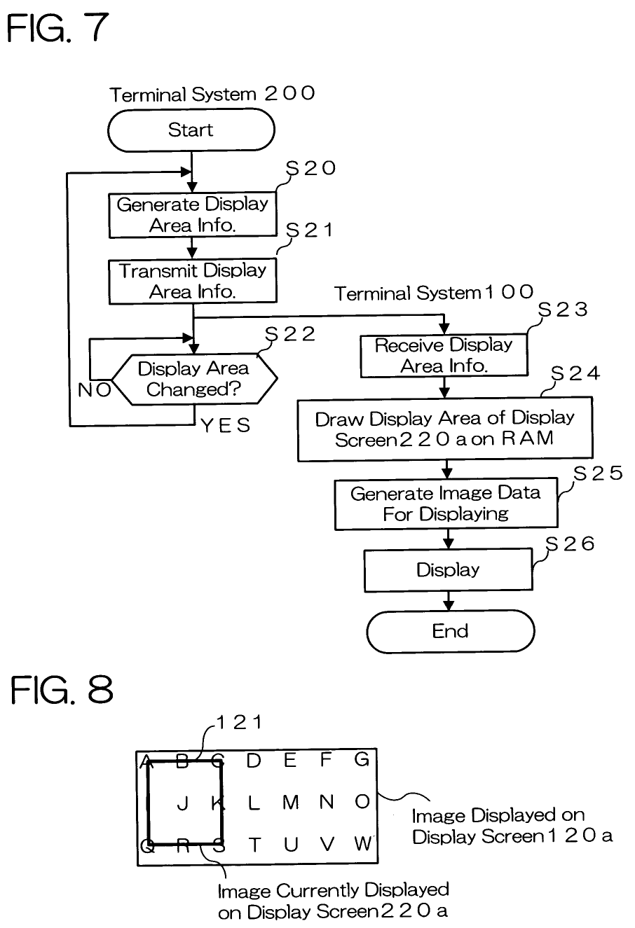

Next, with reference to FIG. 7, a display area displaying process for displaying the display area of the terminal system 200 in the terminal system 100 will be explained. FIG. 7 is a flowchart showing the display area displaying process.

In FIG. 7, at first, the CPU 211 of the terminal system 200 generates display area information, which is one example of the “first display area information” of the present invention (step S20). For example, the display area information is about an area of the shared image which is currently displayed on the display screen 220a in the terminal system 200 (i.e. one example of the “first area occupied by the at least one portion displayed on the first screen device with respect to the whole area of the image”). For example, the display area information is coordinate data for indicating the position of this area of the shared image.

Then, the CPU 211 transmits this display area information to the terminal system 100 by the communication device 240 (step S21). Incidentally, the operation on the terminal system 100 side as being the destination will be explained later.

After transmitting the display area information, the CPU 211 judges whether or not the portion of the shared image displayed on the display screen 220a is changed by the operation of the user 200a, for example (step S22). If such a change is not made (the step S22: NO), the CPU 211 repeats this type of judgment for each constant clock. If the display portion is changed (the step S22: YES), the CPU 211 returns the process to the step S20 again, newly generates the display area information corresponding to the change, and transmits it to the terminal system 100.

On the other hand, in the terminal system 100 which is the destination of the display area information, the communication device 150 receives the display area information (step S23). After the display area information is received, the CPU 111 draws the area of the shared image which is currently displayed in the terminal system 200, on the basis of the coordinate data included in the display area information, on the image developed on the RAM 113 (step S24).

After drawing the display area of the terminal system 200 on the RAM 113, the CPU generates image data for displaying which is to be displayed on the display device 120 again (step S26). Then, the display area displaying process ends.

Now, with reference to FIG. 8, the result of the display area displaying process will be explained. FIG. 8 is a schematic diagram showing the display screen 120a in the terminal system 100.

In FIG. 8, in the image displayed on the display screen 120a, a frame-like pointer 121 for indicating the area of the shared image which is currently displayed on the display screen 220a is displayed. This frame-like pointer 121 is one example of the “information corresponding to the first area” of the present invention. Incidentally, such information for indicating the area of the share image which is currently displayed on the display screen 220a is not limited to the frame-like pointer 121. For example, it may be hatching, or have an aspect of indicating the corners of the area with pointers, or the like.

### 3. Indicated Point Displaying Process

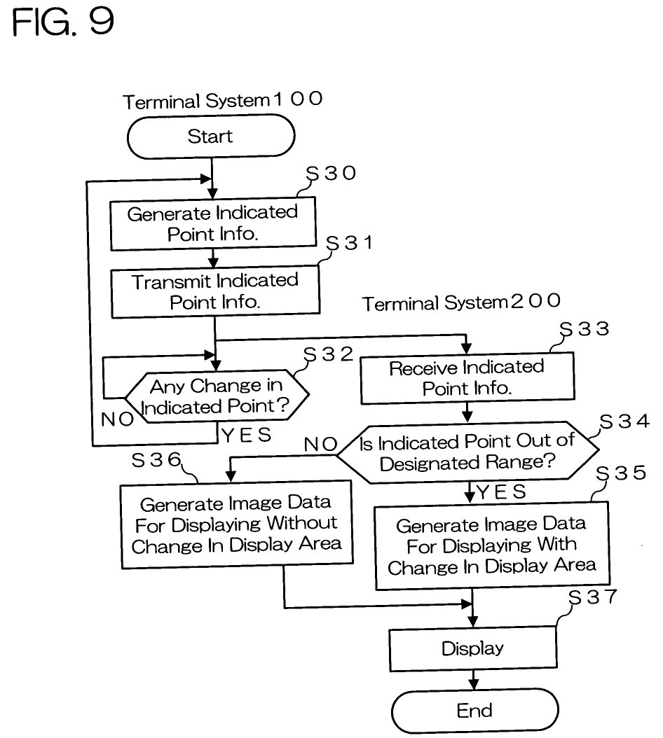

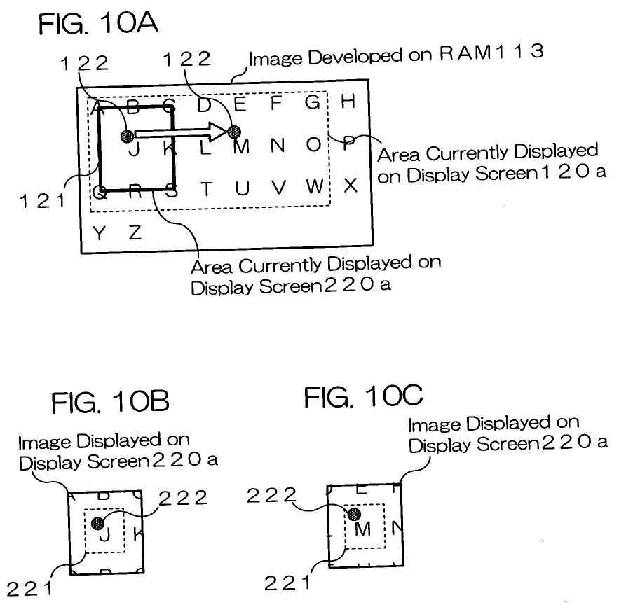

Next, with reference to FIG. 9 and FIG. 10, as occasion demands, an indicated point displaying process for displaying, in the terminal system 200, the indicated point of the terminal system 100 will be explained. FIG. 9 is a flowchart showing the indicated point displaying process. FIG. 10A to FIG. 10C are schematic diagrams showing respective display screens related to the indicated point displaying process.

In FIG. 9, at first, the CPU 111 of the terminal system 100 generates indicated point information for representing an indicated point of the display screen 120a (step S30). The indicated point herein is a point on the image which is indicated by the user 100a using the input device 130 and which is displayed on the display screen 120a. In the embodiment, it is assumed that the indicated point is displayed on the display screen 120a. Therefore, the indicated point information includes the coordinate data of the indicated point. The generated indicated point information is transmitted from the communication device 150 to the terminal system 200 (step S31).

After transmitting the indicated point information, the CPU 111 judges whether or not there is a change in the indicated point, in accordance with constant clock timing (step S32). If there is not any change in the indicated point (the step S32: NO), the CPU 111 repeats the process of the step S32. If there is a change in the indicated point (the step S32: YES), the CPU 111 returns the process to the step S30 again, newly generate the indicated point information, and transmits it to the terminal system 200.

In FIG. 10A, the indicated point is displayed as a pointer 122 on the display screen 120a. The pointer 122 is located in the area of the shared image which is currently displayed on the display screen 220a in the terminal system 200; namely, in the frame-like pointer 121 on the display screen 120a. The pointer 122 is located in the vicinity of the upper left of “J”. The indicated point information includes coordinate information corresponding to the vicinity of the upper left of “J”.

Back in FIG. 9, in the terminal system 200, the indicated point information is received by the communication device 240 (step S33). The CPU 211 judges whether or not the indicated point is out of a designated area set in advance by the user 200a in the terminal system 200, on the basis of the indicated point information received (step S34).

The designated range herein is a designated range 221 set as an arbitrary range on the display device 220, as shown in FIG. 10B. The designated range 221 is one example of the “second range” of the present invention. The designated range 221 is set to be, for example, “the 50% range of the size of an area displayed with the center of the display screen 220a as the center”, or the like.

If there is the indicated point in the designated range 221 (the step S34: NO), the CPU 211 does not change the area itself of the shared image displayed on the display screen 220a, but generates the image data for displaying which is intended to display a pointer 222 corresponding to the pointer 122 at a point of coordinates indicated by the indicated point information (step S36), and allows or controls the display screen 220a to display it (step S37).

On the other hand, if there is the indicated point out of the designated range 221 (the step S34: YES), the CPU 211 generates the image data for displaying so as to include the indicated point in the designated range 221 (step S35). At this time, the data for displaying which is intended to display the pointer 222 at a position corresponding to the indicated point is generated and displayed on the display screen 220a (step S37). If the image including the indicated point is displayed by the step S37, the indicated point displaying process ends.

For example, in FIG. 10A, it is assumed that the pointer 122 is displaced to the right and displayed in the vicinity of the upper left of “M”. In this case, the indicated point is not in the designated range 221 in FIG. 10B, so that an image as shown in FIG. 10C is newly displayed on the display screen 220a. Incidentally, the data for displaying which is newly generated in the terminal system 200 may be data generated to display the pointer 222 on the center of the display screen 220a. Alternatively, it may be data generated to display the pointer 222 in a different designated range (i.e. the “first range” of the present invention) from the designated range 221.

As explained above, in the image sharing display system 10, the terminal system 100 can recognize which portion of the shared image is currently displayed in the terminal system 200. Therefore, the user 100a can keep giving proper attention to the user 200a, which results in smooth communication.

Moreover, in the image sharing display system 10, the display content of the display screen 220a is automatically changed in the terminal system 200, to follow the point indicated on the display screen 120a in the terminal system 100. Therefore, it is possible to remarkably reduce the operational load of the user 200a who operates the terminal system 200, which results in smoother communication.

Incidentally, there is the case where it is not desired to follow the operation performed in the terminal system 100. In preparation for that case, the decision of the following may be set on the terminal system 200 side, for example.

Moreover, in the above-mentioned indicated point displaying process, the user 100a who operates the terminal system 100 can indicate an arbitrary point on the display screen 120a, particularly without conscious of forcibly controlling the display content on the terminal system 200 side. However, the user 100a can control the display content of the terminal system 200 with a much clear intention. In this case, for example, it may be constructed such that the user 100a can arbitrarily displace the frame-like pointer 121 displayed on the display screen 120a. The displacement of the frame-like pointer 121 may be converted to the coordinate data, for example, and may be transmitted to the terminal system 200, as one example of the “area designation information” of the present invention. Namely, in this case, the CPU 111 functions as one example of the “area designation information generating device” of the present invention. At this time, on the terminal system 200 side, the CPU 211 changes the display content of the display screen 220a, on the basis of the area designation information.

### MODIFIED EXAMPLE

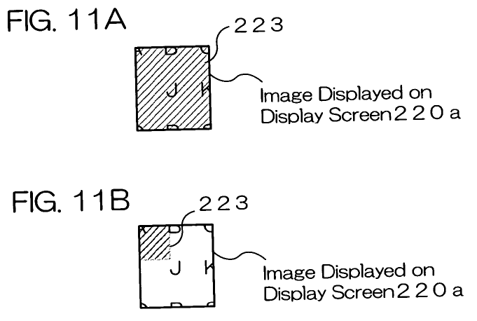

In the embodiment, only on the terminal system 100 side, the display area on the other side is displayed on the display device. However, on the both terminal systems, the display area on the other side may be mutually displayed. With reference to FIG. 11A and FIG. 11B, such a modified example of the present invention will be explained. FIG. 11A and FIG. 11B are schematic diagrams showing one aspect of the display screen 220a in the terminal system 200.

In FIG. 11A, an area of the shared image which is currently displayed on the display screen 120a (i.e. one example of the “second area occupied by the at least one portion displayed on the second screen device with respect to the whole area of the image”) is displayed as a hatching portion 223 (i.e. one example of the “information corresponding to the second area” of the present invention) on the display screen 220a. This hatching portion 223 allows the user 200a to recognize that the image which is currently displayed on the display screen 220a is recognized in the terminal system 100 (i.e. by the user 100a). For example, as shown in FIG. 11A, if the hatching portion 223 is formed over the whole area of the display screen 220a, the image displayed on the display screen 220a will be all included in the image displayed on the display screen 110a. On the other hand, as shown in FIG. 11B, if the hatching portion 223 is a part of the display screen 220a, the user 200a can visually recognize that a range out of the hatching portion 223 is a portion not-displayed on the display screen 110a. Therefore, it is possible to make communication, more smoothly.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-218538 filed on Jul. 27, 2004 including the specification, claims, drawings and summary is incorporated herein by reference in its entirety.

What is claimed is:

1. An image sharing display system, comprising:
at least one first terminal and at least one second terminal which are accommodated in a network and which can mutually share an image,
said first terminal comprising:
a first screen device for displaying the image;
a first display controlling device for controlling said first screen device to display at least one portion of the image;
a first display area information generating device for generating first display area information which indicates a first area occupied by the at least one portion displayed on said first screen device with respect to a whole area of the image; and
a first communicating device for transmitting the generated first display area information to said second terminal through the network,
said second terminal comprising:
a second screen device for displaying the image; and
a second display controlling device for controlling said second screen device to display at least one portion of the image.

2. The image sharing display system according to claim 1, wherein said second terminal further comprises:
a second display area information generating device for generating second display area information which indicates a second area occupied by the at least one portion displayed on said second screen device with respect to the whole area of the image; and
a second communicating device for transmitting the generated second display area information to said first terminal through the network.

3. The image sharing display system according to claim 2, wherein said second display controlling device controls said second screen device to display information corresponding to the first area, on the basis of the transmitted first display area information.

4. The image sharing display system according to claim 3, wherein said second screen device has a larger display area than that of said first screen device.

5. The image sharing display system according to claim 2, wherein said first display controlling device controls said first screen device to display information corresponding to the second area, on the basis of the transmitted second display area information.

6. The image sharing display system according to claim 2, wherein
said second terminal further comprises an area designation information generating device for generating area designation information which designates an area of the image to be displayed on said first screen device,
said second communicating device transmits the generated area designation information to said first terminal, and
said first display controlling device controls said first screen device to display the designated area, on the basis of the transmitted area designation information.

7. The image sharing display system according to claim 2, wherein
said second terminal further comprises an indicated point information generating device for generating indicated point information which represents a point indicated in the second area,
said second communicating device transmits the generated indicated point information to said first terminal, and
said first display controlling device controls said first screen device to display information corresponding to the indicated point, on the basis of the transmitted indicated point information.

8. The image sharing display system according to claim 7, wherein said first display controlling device controls said first screen device to display at least one portion of the image so as to include the indicated point in a first range set in advance on said first screen device, on the basis of the transmitted indicated point information.

9. The image sharing display system according to claim 8, wherein
said first terminal further comprises a judging device for judging whether or not the indicated point is out of a second range set in advance on the first screen device, and
said first display controlling device controls said first screen device to display at least one portion of the image so as to include the indicated point in the first range, if it is judged by said judging device that the indicated point is our of the second range.

10. The image sharing display system according to claim 1, wherein the image is supplied in advance from said first or second terminal through said first or second communicating device.

11. A terminal with an image sharing function which is accommodated in a network and which can mutually share an image through the network with another terminal having a first screen device for displaying at least one portion of the image,
said terminal with the image sharing function comprising:
a second screen device for displaying the image; and
a display controlling device for controlling said second screen device to display at least one portion of the image,
said display controlling device controlling said second screen device to display information corresponding to a first area, on the basis of first display area information which is transmitted from the another terminal and which indicates a first area occupied by the at least one portion displayed on said first screen device with respect to a whole area of the image.

12. The terminal with the image sharing function according to claim 11, further comprising:
an indicated point information generating device for generating indicated point information which represents a point indicated on said second screen device; and
a communicating device for transmitting the generated indicated point information through the network,
said terminal with the image sharing function allowing said first screen device to display at least one portion of the image so as to include the indicated point, on the basis of the transmitted indicated point information.

13. A computer program product in a computer-readable medium for tangibly embodying a program of instructions executable by a computer system to make the computer system function as a first terminal in an image sharing display system, comprising:
at least one first terminal and at least one second terminal which are accommodated in a network and which can mutually share an image,
said first terminal comprising:
a first screen device for displaying the image;
a first display controlling device for controlling said first screen device to display at least one portion of the image;
a first display area information generating device for generating first display area information which indicates a first area occupied by the at least one portion displayed on said first screen device with respect to a whole area of the image; and
a first communicating device for transmitting the generated first display area information to said second terminal through the network,
said second terminal comprising:
a second screen device for displaying the image; and
a second display controlling device for controlling said second screen device to display at least one portion of the image.

14. A computer program product in a computer-readable medium for tangibly embodying a program of instructions executable by a computer system to make the computer system function as a second terminal in an image sharing display system, comprising:
at least one first terminal and at least one second terminal which are accommodated in a network and which can mutually share an image,
said first terminal comprising:
a first screen device for displaying the image;
a first display controlling device for controlling said first screen device to display at least one portion of the image;
a first display area information generating device for generating first display area information which indicates a first area occupied by the at least one portion displayed on said first screen device with respect to a whole area of the image; and
a first communicating device for transmitting the generated first display area information to said second terminal through the network,
said second terminal comprising:
a second screen device for displaying the image; and
a second display controlling device for controlling said second screen device to display at least one portion of the image.
